(19) United States
(12) Patent Application Publication
(10) Pub. No.: US 2016/0219253 A1
(43) Pub. Date: Jul. 28, 2016

(54) DIVING PHOTOGRAPHING SYSTEM AND DIVING PHOTOGRAPHING DEVICE THEREOF

(71) Applicant: Shenzhen AEE Technology Co., Ltd., Shenzhen, Guangdong (CN)

(72) Inventor: Xianzhi Zhang, Shenzhen, Guangdong (CN)

(73) Assignee: SHENZHEN AEE TECHNOLOGY CO., LTD, Shenzhen, Guangdong (CN)

(21) Appl. No.: 14/764,573

(22) PCT Filed: May 13, 2014
(86) PCT No.: PCT/CN2014/077384

§ 371 Date: Jul. 30, 2015

(51) Int. Cl. H04N 7/18; G03B 17/08; G03B 17/38; H04N 5/225

(52) U.S. Cl. CPC H04N 7/185; H04N 5/2252; G03B 17/08; G03B 17/38

(57) ABSTRACT

The present disclosure provides a diving photographing device. The diving photographing device includes a base for mounting a diving photographing apparatus, a first handle and a second handle arranged on the base to be handheld by a user, a remote control device arranged in the diving photographing device for remote control of the diving photographing apparatus; the remote control device includes a triggering switch arranged on the first handle and being operable by a user and a remote control circuit board connected to the triggering switch; and the triggering switch is wirelessly connected to the diving photographing apparatus. The present disclosure further provides a diving photographing system with the above diving photographing apparatus. The diving photographing device allows the user to conveniently handhold and operate the diving photographing apparatus.

### BACKGROUND

1. Technical Field

The present invention relates to diving photographing technologies, and particularly, to a diving photographing system and a diving photographing device thereof.

2. Description of Related Art

When using a photographing apparatus under water, a user generally wears a diving device such as diving suits and diving gloves. The diving device, especially the rubber gloves may seriously affect the touch of the user; in addition, due to the thickness of the gloves, accurately controlling the diving apparatus may become difficult for the user. Thus, the user who is diving cannot handhold the photographing apparatus nor press the shutter quickly and accurately. In particular, when a waterproof housing is sleeved on the photographing apparatus, it is more difficult for the user to operate the diving photographing apparatus. Therefore, how to stably and conveniently control the photographing apparatus under water becomes a problem needed to be solved.

### SUMMARY

The main purpose of the invention is to provide a diving photographing device allowing the user to handhold and operate the diving apparatus conveniently.

According to an aspect of the present disclosure, a diving photographing device includes a base for mounting a diving photographing apparatus, a first handle and a second handle arranged on the base to be handheld by a user, a remote control device arranged in the diving photographing device for remote control of the diving photographing apparatus; the remote control device includes a triggering switch arranged on the first handle and being operable by a user and a remote control circuit board connected to the triggering switch; the triggering switch is wirelessly connected to the diving photographing apparatus.

Preferably, the remote control device further includes a first battery supplying power for the remote control circuit board, and the first battery and the remote control circuit board are detachably mounted in the first handle.

Preferably, the first battery includes a positive terminal connected to the remote control circuit board and a negative terminal corresponding to the positive terminal; a battery seat and a metal housing are arranged in the first handle, the battery seat is connected to the negative terminal for mounting the battery, and the metal housing is sleeved on a circumferential surface of the first battery; one end of the metal housing is connected to the battery seat to be conductive to the negative terminal, the other end of the metal housing is electrically connected to the remote control circuit board; two poles of the first battery are respectively connected to the remote control circuit board to supply power for the first remote control circuit board.

Preferably, the first handle includes a supporting member arranged adjacent to the first battery for supporting the first handle and a covering cap connected to an upper end of the supporting member; an inner circumferential surface of a lower end of the supporting member is tightly engaged with the an outer circumferential surface of a lower end of the battery seat to enclose a lower end of the first handle; and the upper end of the supporting member is tightly engaged with a lower end of the covering cap to enclose an upper end of the first handle.

Preferably, a connecting section is arranged between the supporting member and the covering cap; the remote control circuit board is arranged in the connecting section; an upper end of the connecting section is tightly engaged with the lower end of the covering cap, and a lower end of the connecting section is tightly engaged with the upper end of the supporting member.

Preferably, a fixing board is arranged on the connecting section and is located under the remote control circuit board, a through hole is defined in the fixing board allowing the first battery to pass therethrough, and the connecting section is fixed to the supporting member through the fixing board.

Preferably, a first annular blocker parallel to the supporting member is arranged under the fixing board for fixing the metal housing.

Preferably, at least one protrusion is arranged on an inner surface of the connecting section for supporting the remote control circuit board, and the at least one protrusion extends along a central line of the first handle.

Preferably, the first handle includes an outer housing fixed to an outer side of the supporting member, a top end of the outer housing is fixed to a bottom end of the connecting section, and a bottom end of the outer housing is fixed to the base.

Preferably, sealing rings are arranged between the covering cap and the connecting section, between the connecting section and the supporting member, and between the supporting member and the base for sealing the first handle.

Preferably, the battery seat includes a thread section connected to the metal housing and a sealing section connected to the lower end of the supporting member; and an annular groove is formed in the sealing section and a sealing ring is arranged in the annular groove for sealing the lower end of the first handle.

Preferably, the supporting member includes a first section connected to the sealing section, a second section located on an outer side of the thread section, and a third section extending from an end portion of the second section towards a top end of the supporting member along the central line of the first handle; a thickness of the first section is greater than that of the second section and the third section; the supporting member includes a second annular blocker located on an outer side of the thread section for fixing the metal housing; and the second annular blocker is connected to the first section and is parallel to the second section.

Preferably, a second battery supplying power for the remote control circuit board is arranged in the second handle.

Preferably, a wireless transmitter connected to the second battery is arranged in the second handle, a wireless receiver connected to the first battery is arranged in the first handle; and the wireless receiver is inductively coupled to the wireless transmitter to supply power.

Preferably, the first handle and the second handle are respectively fixed to two ends of the base and extend from the same side of the base along the same direction; and a mounting portion for mounting the diving photographing device is arranged on the base and is located between the first handle and the second handle.

Preferably, the mounting portion defines a plurality of screw holes, and the screw holes are configured to fix a pluggable base or a waterproof housing adapted to the diving photographing apparatus.

Preferably, the diving photographing device further includes a floating member arranged on the base for increasing a flotation force of the diving photographing device under water.

Preferably, the floating member is fixed to one side of the base corresponding to the first handle and the second handle.

Preferably, the base further defines a plurality of thread openings for fixing an illumination light and a light battery, at least one bolt through hole extending along a lengthwise direction of the base for adjustably mounting the illumination light, and at least one rope hole which can be tied to a safety rope connected to a diving suit.

According to another aspect of the present disclosure, a diving photographing system is provided. The diving photographing system includes a diving photographing device and a photographing apparatus mounted on the diving photographing device, wherein the diving photographing device includes a base for mounting the diving photographing device, a first handle and a second handle arranged on the base to be handheld by a user, a remote control device arranged in the diving photographing device for remote control of the diving photographing apparatus; the remote control device includes a triggering switch arranged on the first handle and being operable by a user and a remote control circuit board connected to the triggering switch; the triggering switch being wirelessly connected to the diving photographing apparatus.

On one hand, the diving photographing device of the present disclosure is provided with the base for mounting the photographing apparatus and the first handle and the second handle to be handheld by the user, thus, the user may handhold the diving photographing device like holding a steering wheel; the user may rotate the diving photographing device clockwise or counterclockwise, or obliquely move the diving photographing device around, thus, the above diving photographing device is conveniently used and operated, and the photographing angle of the photographing device is conveniently adjusted by the user. On the other hand, by providing the remote control device on the diving photographing device and arranging the triggering switch on the first handle, the user is capable of handholding the first handle with one hand and controlling the photographing device without leaving the hand from the first handle, thereby facilitating the user's operation.

### DESCRIPTION OF THE DRAWINGS

FIG. 1 is a schematic view of a diving photographing device in accordance with an exemplary embodiment of the present disclosure;

FIG. 2 is a cross-section view of the diving photographing device of FIG. 1;

FIG. 3 is an enlarged view of a section A in FIG. 2;

FIG. 4 is an enlarged view of a section B in FIG. 3;

FIG. 5 is an enlarged view of a section C in FIG. 4;

FIG. 6 is a schematic view of a remote control circuit board of FIG. 3; and

FIG. 7 is similar to FIG. 6, but viewed from another angle.

The realization of the object, features, and advantages of the present disclosure are given in further detail in combination with the embodiments with reference to the accompanying drawings.

### DETAILED DESCRIPTION

It should be understood that the embodiments described herein are only used to explain the present disclosure rather than to limit the present disclosure.

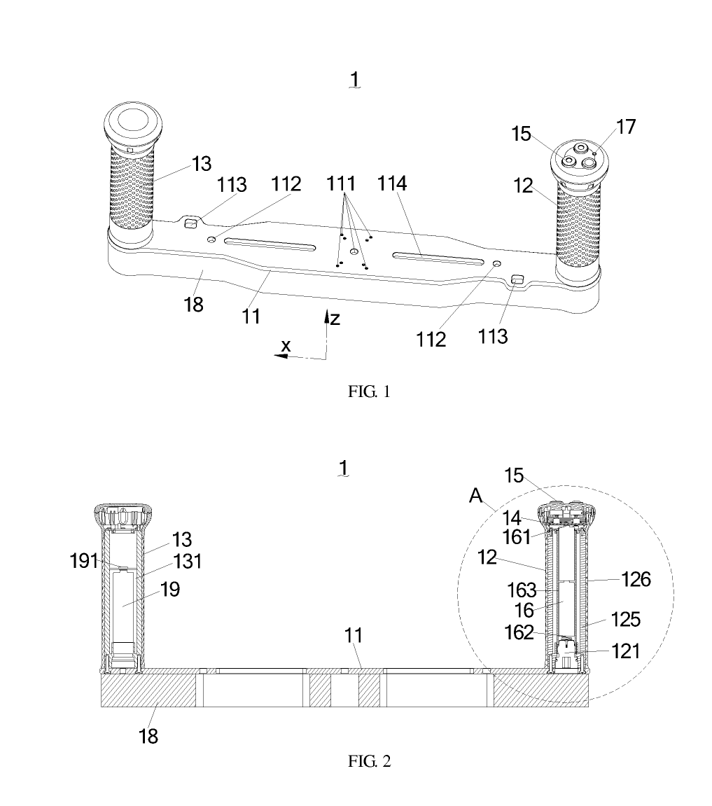

It is noted that following definitions are made according to the rectangular coordinate system built in FIG. 1: a side corresponding to the positive axis X is defined as the left side, a side corresponding to the negative axis X is defined as the right side, a side corresponding to the positive axis Z is defined as the upper side, and a side corresponding to the negative axis Z is defined as the lower side.

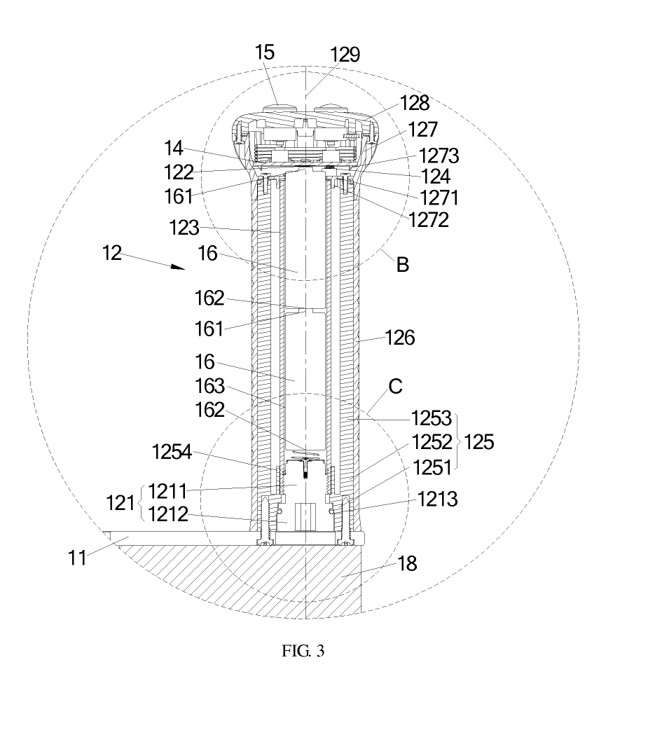

FIGS. 1 and 2 show a diving photographing device 1 in accordance with an exemplary embodiment of the present disclosure. The diving photographing device 1 includes a base 11 configured to mount a photographing apparatus, a first handle 12 and a second handle 13 arranged on the base 11 to be handheld by a user, and a remote control device arranged inside the diving photographing device allowing for remote control of the photographing apparatus. The remote control device includes a triggering switch 15 arranged on the first handle 12 being operable by the user and a remote control circuit board 14 connected to the triggering switch 15. The trigging switch 15 is wirelessly connected to the photographing apparatus through the remote control circuit board 14.

As stated above, the diving photographing device includes the base 11 for mounting the photographing apparatus, and the first handle 12 and the second handle 13 to be handheld by a user, thus, the user may handhold the diving photographing device like handholding a steering wheel to place the diving photographing device 1 in his/her chest. In usage, the user may rotate the diving photographing device 1 clockwise or counterclockwise or obliquely move the diving photographing device 1 around, thus, the above diving photographing device 1 can be conveniently used and operated, and the photographing angle of the photographing device can be conveniently adjusted by the user. Furthermore, by providing the remote control device on the diving photographing device 1 and arranging the triggering switch 15 on the first handle 12, the user is capable of handholding the first handle 12 with one hand and controlling the photographing device without leaving the hand from the first handle 12, thereby facilitating the user's operation.

Referring to FIGS. 2 and 3, furthermore, the remote control device includes a first battery 16 supplying power for the remote control circuit board 14. The first battery 16 and the remote control circuit board 14 are detachably mounted in the first handle 12. Through the arrangement of the first battery 16 and the remote control circuit board 14, the distance between the three elements, that is, the first battery 16, the remote control circuit board 14, and the triggering switch 15 is relatively small, which reduces the layout and thus simplifies the structure of the diving photographing device 1. It is noted that in other embodiments, the remote control circuit board 14 and the first battery 16 may be arranged on the base 11.

In the embodiment, the first battery 16 is a cylindrical standard battery such as an AA battery, allowing for convenient replacement and purchase of the first battery 16. In other embodiments, the first battery 16 can be a lithium battery with a different shape.

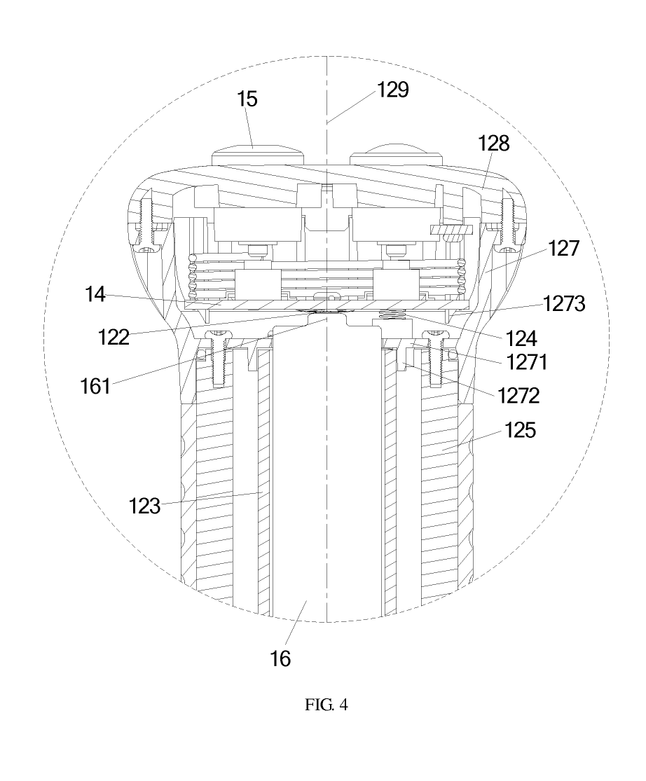

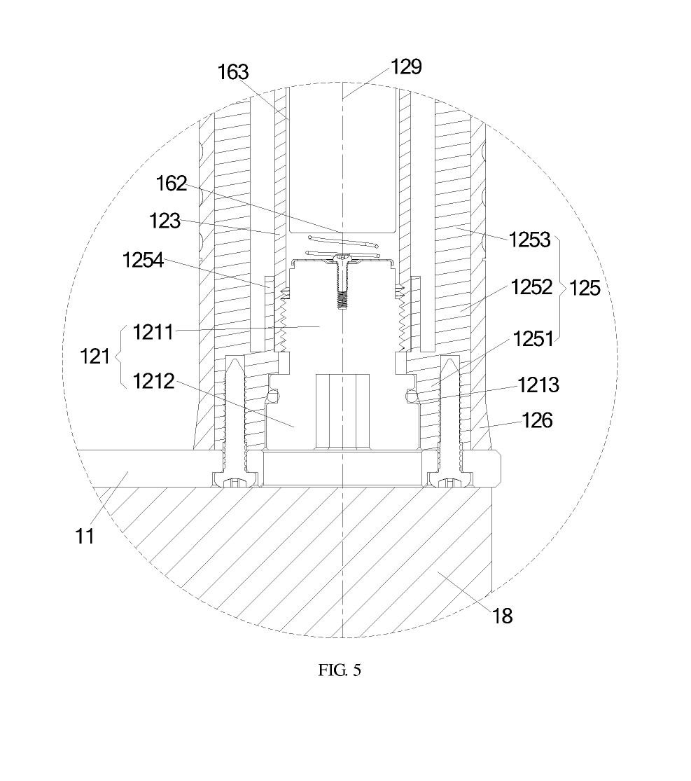

Referring to FIGS. 4 to 7, the first battery 16 includes a positive terminal 161 connected to the remote control circuit board 14 and a negative terminal 162 corresponding to the positive terminal 161. Similarly, in other embodiments, the negative terminal 162 may be connected to the remote control circuit board 14. Optionally, the distance between the positive terminal 161 and the remote control circuit board 14 may be equal to that between the negative terminal 162 and the remote control circuit board 14.

The first handle 12 includes a battery seat 121 connected to the negative terminal 162 for mounting the first battery 16, a metal elastic piece 122 connected to the positive terminal 161, and a metal housing 123 sleeved on a circumferential surface of the first battery 16. One end (e.g., the lower end) of the metal housing 123 is connected to the battery seat 121, and the other end (e.g., the upper end) of the metal housing 123 is electrically connected to the remote control circuit board 14. In the embodiment, the upper end of the metal housing 123 is electrically connected to the remote control circuit board 14 through a spring 124. In such way, the first battery 16 can be conveniently detached. The metal elastic piece 122 is fixed to the lower side of the remote control circuit board 14 and is electrically connected to the remote control circuit board 14. Two poles of the first battery 16 are conducted to the remote control circuit board 14 through the metal elastic piece 122 and the metal housing 123, respectively, thereby supplying power for the remote control circuit board 14.

The first handle 12 further includes a supporting member 125 and a covering cap 128. The supporting member 125 is arranged adjacent to the first battery 16 for supporting the first handle 12, and the covering cap 128 is connected to an upper end of the supporting member 125. An inner circumferential surface of a lower end of the supporting member 125 is tightly engaged with an outer circumferential surface of a lower end of the battery seat 121 to enclose the lower end of the first handle 12. The upper end of the supporting member 125 is tightly engaged with a lower end of the covering cap 128 to enclose the upper end of the first handle 12. In detail, in the embodiment, an outer circumferential surface of the upper end of the supporting member 125 is tightly engaged with an inner circumferential surface of the lower end of the covering cap 128.

A hollow connecting section 127 is arranged between the supporting member 125 and the covering cap 128. The remote control circuit board 14 is arranged in the connecting section 127. An upper end of the connecting section 127 is tightly engaged with the lower end of the covering cap 128, and a lower end of the connecting section 127 is tightly engaged with the upper end of the supporting member 125. The upper end and the lower end of the supporting member 125 are secured to the base 11 and the connecting section 127 through screws, respectively. The connecting section 127 is secured to the covering cap 128 through screws; in detail, an inner circumferential surface of the lower end of the connecting section 127 is tightly connected to an outer circumferential surface of the upper end of the supporting member 125.

A fixing board 1271 is arranged on the connecting section 127 and is located under the remote control circuit board 14. In the embodiment, the fixing board 1271 is formed by extending the inner circumferential surface of the connecting section 127 towards a central line 129 of the connecting section 127. A circular hole (the hole is not shown for being filled with the first battery 16) allowing the first battery 16 to pass therethrough is defined in the fixing board 1271. The connecting section 127 is fixed to the supporting member 125 through the fixing board 1271. In detail, a screw hole is defined in the supporting member 125, a through hole corresponding to the screw hole is defined in the fixing board 1271, and a screw bolt is screwed into the screw hole by passing through the through hole to connect the supporting member 125 to the fixing board 1271.

A first annular blocker 1272 parallel to the first supporting member 125 is arranged under the fixing board 1271 for fixing the metal housing 123. The metal housing 123 is inserted into the first annular blocker 1272 and abuts an inner surface of the first annular blocker 1272. In such way, during assembly of the diving photographing device, the metal housing 123 is fixed when the connecting section 127 is fixed to the supporting member 125. After that, the first battery 16 and the remote control circuit board 14 can form a closed loop by fixing the remote control circuit board 14 with the spring 124 and the metal elastic piece 122 to the connecting section 127, which facilitates the assembly of the diving photographing device.

At least one protrusion 1273 is arranged on an inner surface of the connecting section 127 for supporting the remote control circuit board 14. The protrusion 1273 extends towards the central line 129 of the first handle 12 for supporting a lower surface of the remote control circuit board 14. It is noted that in other embodiments, a screw hole may be defined in the protrusion 1273 and the remote control circuit board 14 can be fixed in the connecting section 127 through screws. Optionally, the remote control circuit board 14 can also be screwly fixed in the connecting section 127 by extending a screw bolt upwards from the supporting member 125 or the fixing board 1271.

The first handle 12 further includes an outer housing 126 fixed to an outer side of the supporting member 125. A top end of the outer housing 126 is fixed to a bottom end of the connecting section 127, and a bottom end of the 126 is fixed to the base 11. Textures are formed on an outer surface of the outer housing 126 for skid prevention and improvement of touch feeling and aesthetic.

Sealing rings are respectively arranged between the covering cap 128 and the connecting section 127, between the connecting section 127 and the supporting member 125, and between the supporting member 125 and the base 11. By arranging sealing rings at the above positions, the first handle 12 provides a good tightness and thus the waterproof performance of the first handle 12 is improved.

The battery seat 121 includes a thread section 1211 connected to the metal housing 123 and a sealing section 1212 connected to the lower end of the supporting member 125. An annular groove 1213 is formed in the sealing section 1212, and a sealing ring for sealing the lower end of the first handle 12 is arranged inside the annular groove 1213.

The supporting member 125 includes a first section 1251 connected to the sealing section 1212, a second section 1252 located on an outer side of the thread section 1211, and a third section 1253 extending from an end portion of the second section 1252 towards the top end of the supporting member 125 along the central line 129 of the first handle 12. A thickness of the first section 1251 is greater than that of the second section 1252 and the third section 1253. The supporting member 125 includes a second annular blocker 1254 located adjacent to the thread section 1211 for fixing the metal housing 123. The second annular blocker 1254 is connected to the first section 1251 and is parallel to the second section 1252. In the process that an inner circumferential surface of the metal housing 123 is screwed to an outer circumferential surface of the thread section 1211 of the battery seat 1211, the second annular blocker 1254 guides the connection and helps to fix the metal housing 123 to the thread section 1211.

In detail, the remote control circuit board 14 is arranged between the first battery 16 and the triggering switch 15, so that the structure of the diving photographing device is reasonable and the layout is simplified. Furthermore, the triggering switch 15 is arranged on an extending end (the end along the positive Y axis) of the first handle 12. When the diving photographing device 1 is used, the user may conveniently press the triggering switch 15 with a thumb. In other embodiments, the triggering switch 15 can be arranged on the circumferential surface of the first handle 12, thus, the user can conveniently press the triggering switch 15 with a forefinger and a middle finger.

Referring to FIG. 7, the triggering switch 15 is a button and the number of the triggering switch 15 is three. The three triggering switches correspond to the photographing function, recording function, and stop recording function of the diving photographing apparatus, respectively. Three triggering elements 143 respectively corresponding to the three triggering switches are arranged on the remote control circuit board 14; when one of the triggering switches 15 is pressed to trigger the corresponding triggering element 143, the remote control circuit board 14 sends the corresponding wireless signal to the photographing apparatus.

In other embodiments, the triggering switch 15 also can be a twisted button. For example, the triggering switch 15 can be a twisted button sleeved on the first handle 12. When the triggering switch 15 is rotated clockwise, the photographing function of the diving photographing apparatus can be implemented; when the triggering switch 15 is rotated counterclockwise, the recording function of the diving photographing device can be implemented; when the triggering switch 15 is returned to a predetermined position, the stop recording function is implemented. When the triggering switch 15 is at the position corresponding to the photographing function, an automatic returning force is applied to the triggering switch 15 to drive the triggering switch 15 to return to the predetermined position.

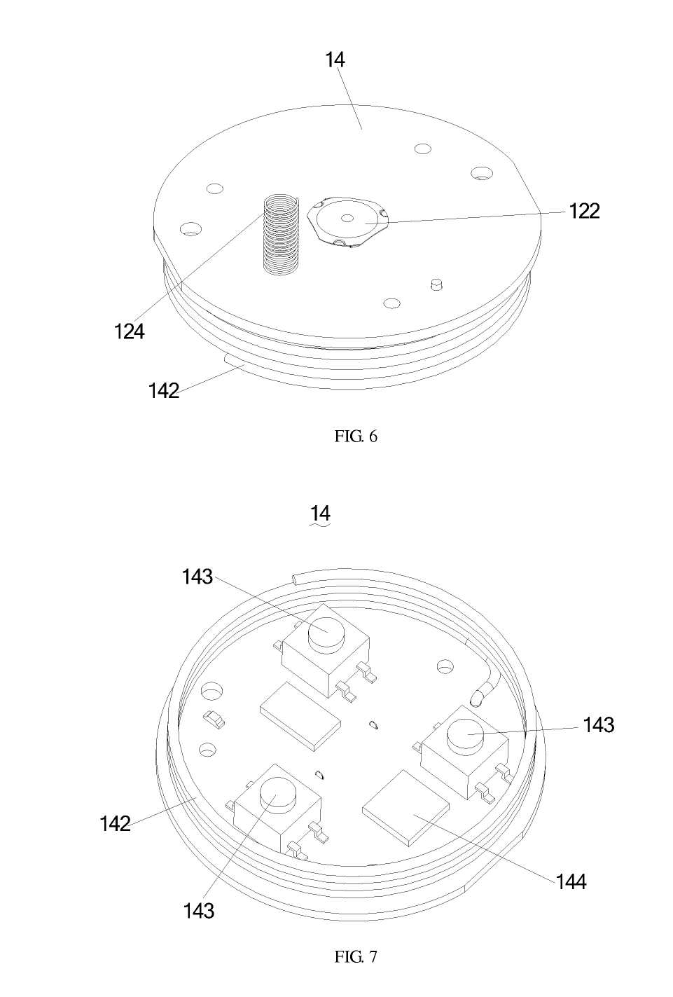

Referring to FIGS. 6 and 7, an antenna 142 of the remote control circuit board 14 is arranged on an external edge of the remote control circuit board 14, thereby reducing the space taken by the remote control circuit board 14 and facilitating the layout of the above structure.

Referring to FIG. 1, the first handle 12 is further provided with an indicator light 17 which is electrically connected to the remote control circuit board 14. The indicator light 17 is located on the extending end of the first handle 12. Through the indicator light 17, the user can understand the current state of the device. For example, through light on, light off, light flashing, and combinations of different light colors, following states of the photographing apparatus can be represented: low battery of the first battery 16, standby state of the photographing apparatus, completion of focusing of the photographing apparatus, lower battery of the photographing apparatus, insufficient storage of the photographing apparatus, disconnection of the photographing apparatus.

In some embodiments, the second handle 13 forms a cavity 131 for accommodating corresponding objects such as an oxygen generator and an emergent inflation floating member. The inner waterproof structure of the second handle 13 is similar to that of the first handle 12. In the embodiment, a second battery 19 is arranged in the second handle 13 for supplying power for the remote control circuit board 14. The second battery 19 is connected to the photographing apparatus or the remote control circuit board 14 through wires preset in the second handle 13 and the base 11. In such way, the second battery 19 can supply power for the photographing apparatus or the remote control circuit board 14 when needed.

Referring to FIGS. 2 and 7, a wireless transmitter 191 connected to the second battery 19 is arranged in the second handle 13, a wireless receiver 144 connected to the first battery 16 is arranged in the first handle 12. The wireless receiver 144 is inductively coupled to the wireless transmitter 191 to supply power, that is, to realize wireless charging. It is noted that in other embodiments, when a wireless charging module is arranged in the photographing device, the second battery 19 can charge the photographing apparatus through the wireless transmitter 191.

Furthermore, the first handle 12 and the second handle 13 are respectively fixed to two ends of the base 11 and extend from the same side of the base 11 along the same direction. For example, in the embodiment, the first handle 12 and the second handle 13 extend upwards (the positive Z axis). A mounting portion for mounting the photographing apparatus is arranged on the base 11 and is located between the first handle 12 and the second handle 13. In the embodiment, the base 11 is elongated, and the left and the right end of the base 11 are two ends of the base 11 along the lengthwise direction of the base 11. When the diving photographing device is used, if the user gets used to operate the diving photographing device with the right hand, the user can hold the first handle 12 with the right hand and hold the second handle 13 with the left hand; at this time, the user can press the triggering switch 15 with the right hand. If the user gets used to operate the diving photographing device with the left hand, the user can hold the first handle 12 with the left hand and hold the second handle 13 with the right hand; at this time, the user can press the triggering switch 15 with the left hand. The two ways of holding the diving photographing device 1 provides good experience to the user.

The mounting portion defines a number of screw holes for fixing a pluggable base or a waterproof housing adapted to the photographing apparatus. The screw holes can be directly connected to an outer housing of the photographing apparatus or the waterproof housing for fixing the photographing apparatus. The pluggable base can be plugged to the photographing apparatus. In such way, the pluggable base can engage with different types of photographing apparatus.

Furthermore, the diving photographing device further includes a floating member 18 arranged on the base 11 configured to increase a flotation force of a remote control frame of the diving photographing device, reduce the falling speed of the frame under water, and reduce the weight of the whole photographing device carried by the user. In detail, the floating member 18 is fixed to one side of the base 11 (eg., the lower surface) corresponding to the first handle 12 and the second handle 13. In the embodiment, the floating member is made of foaming material and is attached to the surface of the base. It is understood that the floating member can be made of other material which can increase the flotation force of the diving photographing device, such as bubble material and plastics. It is noted that it other embodiments, the upper end of the first handle 12 and the upper end of the second handle 13 may be formed with cavities, or the diving photographing device 1 can be made of engineering plastics with holes, thereby reducing the weight of the diving photographing device 1 while keeping the displacement of the diving photographing device 1 unchanged.

Furthermore, the base 11 further defines a plurality of thread openings 112 and a plurality of bolt through holes 114 extending along the lengthwise direction of the base 11. The thread openings 112 are configured to fix an illumination light and a battery used in the illumination light. The bolt through holes 114 are configured to adjust the position of the illumination light, such that the user can adjust the mounting position of the illumination light.

Furthermore, the base 11 defines at least one rope hole 113. The rope hole 113 is configured to be tied to a safety rope which is connected to the diving suit, thereby preventing the remote control frame of the diving photographing device from falling off. In detail, the number of the rope hole 113 is two and the two rope holes 113 are respectively adjacent to the front side and the rear side of the base 11.

When using the diving photographing device 1, the user may hold the first handle 12 and the second handle 13 with two hands respectively, thereby controlling the direction of the photographing apparatus mounted on the base 11. When photographing or recording is required, the user may operate the photographing or recording button of the first handle 12 to take pictures or recording videos, which is convenient under water. Moreover, the structure of the diving photographing device is simple and the weight thereof is light, allowing the diving photographing device to be portably carried under water.

The present disclosure further provides a diving photographing system, including the diving photographing device and the diving photographing apparatus mounted in the diving photographing device as stated above. The structure of the diving photographing device is not given in detail herein. It is noted that since the diving photographing device as stated above is adopted in the diving photographing system, the diving photographing system has the advantages of the diving photographing device.

The present invention is not limited to the above embodiments, and various modifications can be performed based on the technical solutions disclosed in the above embodiments.

1. A diving photographing device, comprising a base for mounting a diving photographing apparatus, a first handle and a second handle arranged on the base to be handheld by a user, a remote control device arranged in the diving photographing device for remote control of the diving photographing apparatus; the remote control device comprising a triggering switch arranged on the first handle and being operable by a user and a remote control circuit board connected to the triggering switch; the triggering switch being wirelessly connected to the diving photographing apparatus.

2. The diving photographing device of claim 1, the remote control device further comprises a first battery supplying power for the remote control circuit board, and the first battery and the remote control circuit board are detachably mounted in the first handle.

3. The diving photographing device of claim 2, wherein the first battery comprises a positive terminal connected to the remote control circuit board and a negative terminal corresponding to the positive terminal; a battery seat and a metal housing are arranged in the first handle, the battery seat is connected to the negative terminal for mounting the battery, and the metal housing is sleeved on a circumferential surface of the first battery; one end of the metal housing is connected to the battery seat to be conductive to the negative terminal, the other end of the metal housing is electrically connected to the remote control circuit board; two poles of the first battery are respectively connected to the remote control circuit board to supply power for the first remote control circuit board.

4. The diving photographing device of claim 3, wherein the first handle comprises a supporting member arranged adjacent to the first battery for supporting the first handle and a covering cap connected to an upper end of the supporting member; an inner circumferential surface of a lower end of the supporting member is tightly engaged with the an outer circumferential surface of a lower end of the battery seat to enclose a lower end of the first handle; and the upper end of the supporting member is tightly engaged with a lower end of the covering cap to enclose an upper end of the first handle.

5. The diving photographing device of claim 4, wherein a connecting section is arranged between the supporting member and the covering cap; the remote control circuit board is arranged in the connecting section; an upper end of the connecting section is tightly engaged with the lower end of the covering cap, and a lower end of the connecting section is tightly engaged with the upper end of the supporting member.

6. The diving photographing device of claim 5, wherein a fixing board is arranged on the connecting section and is located under the remote control circuit board, a through hole is defined in the fixing board allowing the first battery to pass therethrough, and the connecting section is fixed to the supporting member through the fixing board.

7. The diving photographing device of claim 6, wherein a first annular blocker parallel to the supporting member is arranged under the fixing board for fixing the metal housing.

8. The diving photographing device of claim 5, wherein at least one protrusion is arranged on an inner surface of the connecting section for supporting the remote control circuit board, and the at least one protrusion extends along a central line of the first handle.

9. The diving photographing device of claim 5, wherein the first handle comprises an outer housing fixed to an outer side of the supporting member, a top end of the outer housing is fixed to a bottom end of the connecting section, and a bottom end of the outer housing is fixed to the base.

10. The diving photographing device of claim 5, wherein sealing rings are arranged between the covering cap and the connecting section, between the connecting section and the supporting member, and between the supporting member and the base for sealing the first handle.

11. The diving photographing device of claim 4, wherein the battery seat comprises a thread section connected to the metal housing and a sealing section connected to the lower end of the supporting member; and an annular groove is formed in the sealing section and a sealing ring is arranged in the annular groove for sealing the lower end of the first handle.

12. The diving photographing device of claim 11, wherein the supporting member comprises a first section connected to the sealing section, a second section located on an outer side of the thread section, and a third section extending from an end portion of the second section towards a top end of the supporting member along the central line of the first handle; a thickness of the first section is greater than that of the second section and the third section; the supporting member comprises a second annular blocker located on an outer side of the thread section for fixing the metal housing; and the second annular blocker is connected to the first section and is parallel to the second section.

13. The diving photographing device of claim 2, wherein a second battery supplying power for the remote control circuit board is arranged in the second handle.

14. The diving photographing device of claim 13, wherein a wireless transmitter connected to the second battery is arranged in the second handle, a wireless receiver connected to the first battery is arranged in the first handle; and the wireless receiver is inductively coupled to the wireless transmitter to supply power.

15. The diving photographing device of claim 1, wherein the first handle and the second handle are respectively fixed to two ends of the base and extend from the same side of the base along the same direction; and a mounting portion for mounting the diving photographing device is arranged on the base and is located between the first handle and the second handle.

16. The diving photographing device of claim 15, wherein the mounting portion defines a plurality of screw holes, and the screw holes are configured to fix a pluggable base or a waterproof housing adapted to the diving photographing apparatus.

17. The diving photographing device of claim 15, further comprising a floating member arranged on the base for increasing a flotation force of the diving photographing device under water.

18. The diving photographing device of claim 17, wherein the floating member is fixed to one side of the base corresponding to the first handle and the second handle.

19. The diving photographing device of claim 15, wherein the base further defines a plurality of thread openings for fixing an illumination light and a light battery, at least one bolt through hole extending along a lengthwise direction of the base for adjustably mounting the illumination light, and at least one rope hole which can be tied to a safety rope connected to a diving suit.

20. A diving photographing system, comprising a diving photographing device and a photographing apparatus mounted on the diving photographing device, wherein the diving photographing device comprises a base for mounting the diving photographing device, a first handle and a second handle arranged on the base to be handheld by a user, a remote control device arranged in the diving photographing device for remote control of the diving photographing apparatus; the remote control device comprising a triggering switch arranged on the first handle and being operable by a user and a remote control circuit board connected to the triggering switch; the triggering switch being wirelessly connected to the diving photographing apparatus.
